(19) United States
(12) Patent Application Publication
(10) Pub. No.: US 2007/0236122 A1
(43) Pub. Date: Oct. 11, 2007

(54) Pre-chamber type spark plug

(76) Inventor: Bruce M. Borror, West Lafayette, IN (US)

Correspondence Address: Caterpillar Inc.;Intellectual Property Dept., AB 6490, 100 N.E. Adams Street, PEORIA, IL, 61629-6490, US

(21) Appl. No.: 11/400,867

(22) Filed: Apr. 10, 2006

(51) Int. Cl. H01T 13/00

(52) U.S. Cl. 313/118

(57) ABSTRACT

A pre-chamber spark plug that includes a base portion, an electrode positioned within the base portion, and an end cap defining an end portion of the spark plug. The end cap is releasably connected to the base portion of the spark plug. A method of making a pre-chamber spark plug is also disclosed. The method includes providing a base portion having a wall with a first connecting mechanism formed thereon, providing an electrode positioned within and supported by the base portion, providing an end cap having a top portion and a flanged portion. The flanged portion has a second connecting mechanism formed thereon, and connects the end cap to the base portion. The first connecting mechanism is configured to cooperate with the second connecting mechanism to releasably connect the end cap and the base portion together.

### TECHNICAL FIELD

The present disclosure relates generally to a spark-ignition device and more particularly to a pre-chamber type spark plug.

### BACKGROUND

Emissions and efficiency continue to drive technology to improve combustion of air and fuel mixtures. Many improvements control the air and fuel mixture. Examples of some combustion of air and fuel mixture improvements include improved combustion chamber design, valve porting, and fuel or air flow and atomization processes. These improvements all generally improve control of the fuel and air mixture.

Unlike in diesel cycle engines, spark ignited engines may also control a combustion event through initiation of a spark. Encapsulated spark plugs have shown improvements gained from improving conditions and mixing of fuel and air along with improvements gained by controlling initiation of the spark. The encapsulated spark plug includes a plug shell surrounding an electrode gap. The plug shell defines a pre-combustion chamber, or an ignition chamber, separated from a combustion chamber. An orifice or orifices are positioned in the plug shell interconnecting the pre-combustion chamber with the combustion chamber. The pre-combustion chamber and the plug shell separate a flame kernel from turbulence in the combustion chamber. As a piston compresses an air and fuel mixture within the combustion chamber, at least a portion of the air and fuel mixture passes through the orifices into the pre-combustion chamber. In general, this type of spark plug operates to inject hot byproducts of initial combustion further into the unburned fuel/air mixture in the main combustion chamber. This is done in order to create greater turbulence and to better disperse the flame front in the fuel/air mixture.

In the pre-combustion chamber, a spark causes the air and fuel mixture to combust creating a pressure rise. As the pressure in the pre-combustion chamber increases and overcomes the pressure within the combustion chamber, hot gasses pass through each orifice into the combustion chamber. The hot gas acts as an ignition torch increasing the combustion rate in the combustion chamber to reduce the masses of unburned air and fuel mixture. U.S. Pat. No. 5,105,780 discloses one such encapsulated spark plug.

Several encapsulated spark plugs are known in the art. One common drawback to them is the inaccessibility to the interior portions of the spark plug. In particular, the inaccessibility is due to the cap that sleeves the mass electrode being welded in place. Additionally, for example, in the '780 patent, welds that are used to attach the plug shell to the plug increase resistance and, therefore, hinder heat transfer away from the orifices. Welding also requires that the cap be made of a material that is easily welded to a steel base material. Making the entire cap out of a precious metal could be cost prohibitive due to the amount of material that would be required. A welded joint also prevents access to the interior of the plug for service work. Service work can include, for example, resetting the prong gap and replacing the mass electrode.

The present invention is directed to overcoming one or more of the issues set forth above.

### SUMMARY OF THE INVENTION

In one aspect of the disclosure, a pre-chamber spark plug is disclosed. The spark plug includes a base portion, an electrode positioned within the base portion, and an end cap. The end cap is releasably connected to the base portion of the spark plug.

In another aspect of the disclosure a method of making a pre-chamber spark plug is disclosed. The method includes the step of providing a base portion having a wall with a first connecting mechanism formed thereon. The method also includes the step of providing an electrode positioned within and supported by the base portion. Another step in the method includes providing an end cap having a top portion and a flanged portion. The flanged portion has a second connecting mechanism formed thereon. Another step in the method includes connecting the end cap to the base portion wherein the first connecting mechanism is configured to cooperate with the second connecting mechanism to releasably connect the end cap and the base portion together.

### BRIEF DESCRIPTION OF THE DRAWINGS

FIG. 1 is a cross-sectional view of a spark ignited internal combustion engine having a spark plug positioned therein.

FIG. 2 is partial cross-sectional view of the spark plug shown in FIG. 1.

FIG. 3 is an enlarged cross-sectional view of the spark plug shown in FIG. 2.

FIG. 4 is an exploded cross-sectional view of the spark plug shown in FIG. 3.

FIG. 5 is an exploded cross-sectional view of a portion of an alternate embodiment of a spark plug.

FIG. 6 is an exploded cross-sectional view of a portion of an alternate embodiment of a spark plug.

FIG. 7 is an enlarged partial cross-sectional view of an alternate embodiment of a spark plug.

### DETAILED DESCRIPTION

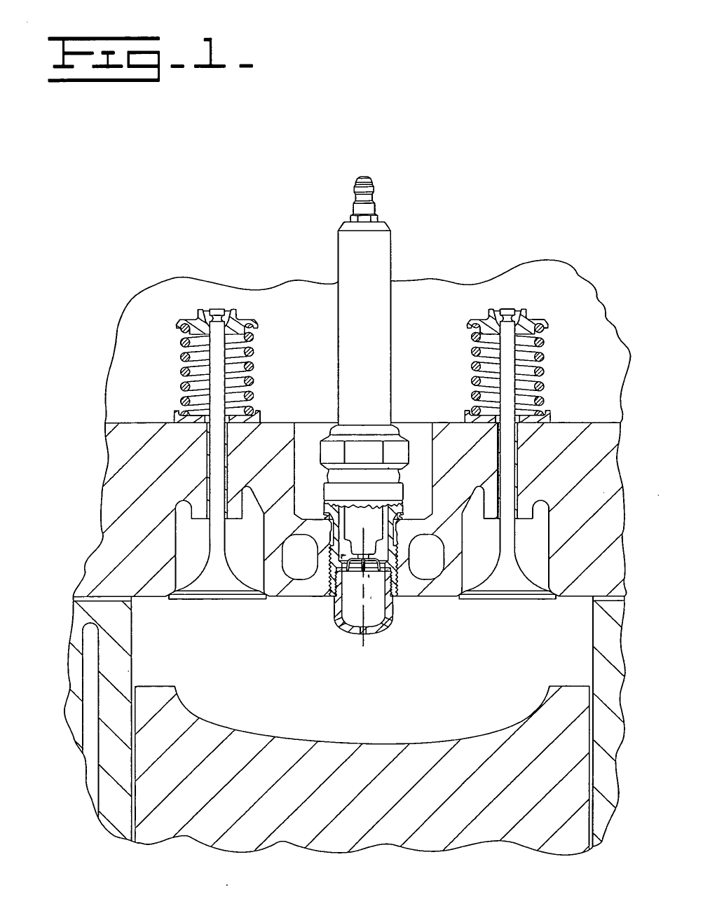

In FIG. 1, a portion of a spark ignition engine 10 is shown. The engine 10 includes a block 12 having a cylinder bore 14 therein. A piston 16 is movably positioned within the cylinder bore 14 in a conventional manner. The block 12 defines a top surface 18.

A cylinder head 22 defines a top surface 24 and a bottom surface 26. The bottom surface 26 of the cylinder head 22 is removably attached to the top surface 18 of the block 12 in a conventional manner, such as by a plurality of bolts, not shown. A gasket 28 is normally interposed between the top surface 18 of the block 12 and the bottom surface 26 of the cylinder head 22. A combustion chamber 30 is defined between the bottom surface 26 of the cylinder head, the cylinder bore 14 of the block, and the piston 16. The cylinder head 22 has at least one intake valve mechanism 34 and at least one exhaust valve mechanism 36 operatively positioned therein. The intake valve mechanism 34 and the exhaust valve mechanism 36 can be operated by a cam, follower and push rod mechanism, not shown, or any other suitable mechanism. For example, the intake valve mechanism 34 and the exhaust valve mechanism 36 could be operated by other means such as hydraulic means or electrical means without changing the overall concept of the design. A stepped through bore 42 is positioned in the cylinder head 22 and extends between the top surface 24 and the bottom surface 26. With the cylinder head 22 positioned on the block, the stepped through bore 42 is substantially centered about the cylinder bore 14 and axis 80. As an alternative, the stepped through bore 42 could be positioned in any manner about the cylinder bore 14. The stepped through bore 42 includes a fastening mechanism 44 of conventional design, such as a threaded portion or a wedge portion to secure a spark plug 50 therein.

As further shown in FIG. 1, a spark plug 50, or another similar mechanism for igniting a combustible mixture, is positioned in the stepped through bore 42. According to the present invention, the spark plug 50 is of the encapsulated design. The spark plug 50 has a connecting portion 52 configured to cooperate with the fastening mechanism 44 of the stepped through bore 42 to hold the spark plug 50 in place. According to the illustrated embodiment, the connecting portion 52 is a threaded connector. However, it can be appreciated that the spark plug 50 can be held in place within the stepped through bore 42 in any manner. For example, the spark plug 50 could be press fit into place, or retained therein using a wedge or other mechanism. The connecting portion 52 and the fastening mechanism 44 of the stepped through bore 42 must be capable of withstanding pressure, temperature and chemistry conditions that are typical of a combustion process. The spark plug 50 is sealingly connected with the cylinder head 22 in a manner that is generally known.

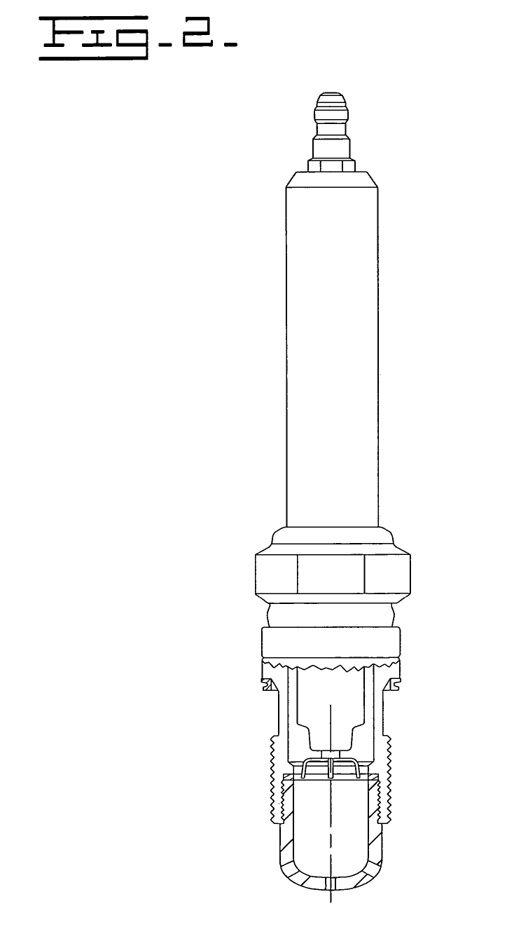

In FIG. 2, an enlarged partially sectioned view of the spark plug 50 is shown. The spark plug 50 includes an insulator retention region 54, an insulator 56, and a terminal 60. The terminal 60 can also be a means for conducting an electrical discharge. The insulator 56 can be any means for insulating. The terminal 60 is made of a material having good electrical conductivity and heat resistance such as a nickel alloy. The insulator 56 operatively electrically isolates the terminal 60 and maintains structural integrity in a high temperature environment. One such material for making the insulator 56 is a ceramic material. The insulator 56 connects and covers the terminal 60. The insulator retention region 54 is made from a material having high thermal conductivity, high thermal stability, and resistance to environmental corrosion. Similarly, corrosion resistant surface treatments may also be used to provide corrosion resistance.

The insulator retention region 54 has plug shell 70, a connection region 72, and a tip and orifice portion 74. The tip and orifice portion 74 also includes a base portion 98 and an end cap 82. The tip and orifice portion 74 has at least one orifice 76 therein. The base portion 98 and the end cap 82 cooperate to form the tip and orifice portion 74. The orifices found in the tip and orifice portion 74 are formed in the end cap portion 82, as will be described next.

As shown in FIG. 2, the orifice 76 is centrally located on the end cap 82. The central orifice 76 is surrounded by a plurality of radially spaced orifices 78. The central orifice 76, in this application, has an axis that is substantially aligned with the axis 80 of the cylindrical bore 14 of the block 12. The spaced orifices 78 are spaced around the periphery of the end cap 82 and are oriented at an angle relative to the axis 80 of the cylinder bore 14. The angle of orientation of the orifices 78 can be an angle other than that shown in the Figures depending on the desired functional characteristics of the spark plug 50. Additionally, the orifices 76, 78 can have any other diameter or size, or any quantity of orifices 76, 78 can be used without departing from the essence of the design. The orifices 76, 78 can also be equally or unequally spaced about the axis 80 in any manner desired.

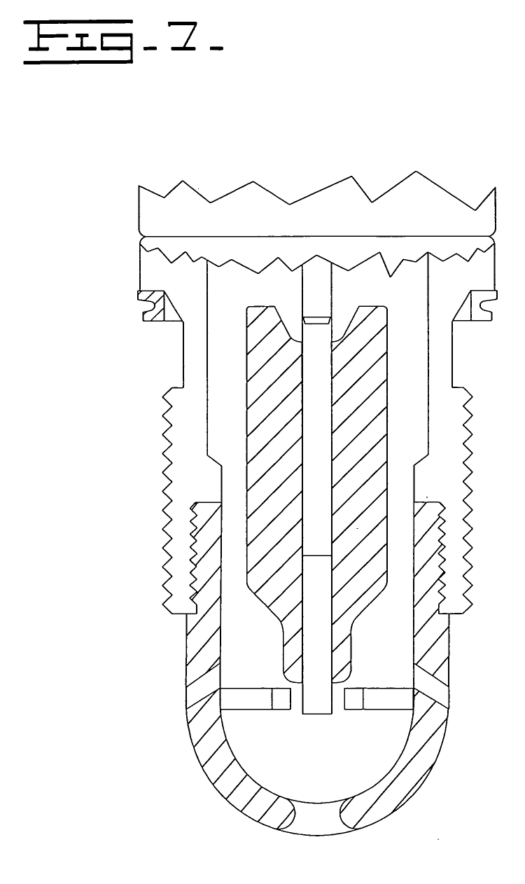

The tip and orifice portion 74 defines a part of the lower portion 90 of the spark plug 50 that, with the spark plug 50 being assembled in the cylinder head 22, is partially aligned below the bottom surface 26 of the cylinder head 22. It should be appreciated that the end cap 82 of the spark plug 50 could be positioned substantially flush with the bottom surface 26 of the cylinder head 22, or further within the combustion chamber 30 if it is so desired, so long as at least one orifice is open to the combustion chamber 30. Additionally, although the end cap 82 of the spark plug 50 is shown as having a block-shaped end, it should be appreciated that the end cap 82 of the spark plug 50 could have a semi-oval configuration or have a parabolic-shaped end that extends beyond the bottom surface 26 of the cylinder head 22 into the combustion chamber 30 (as can be seen in FIG. 7). A pre-combustion chamber 86 is defined between the end cap 82 of the spark plug 50 and the base portion 98. Thus, the end cap 82, the base 98, the insulator retention region 54, and the insulator 56 define the pre-combustion chamber 86.

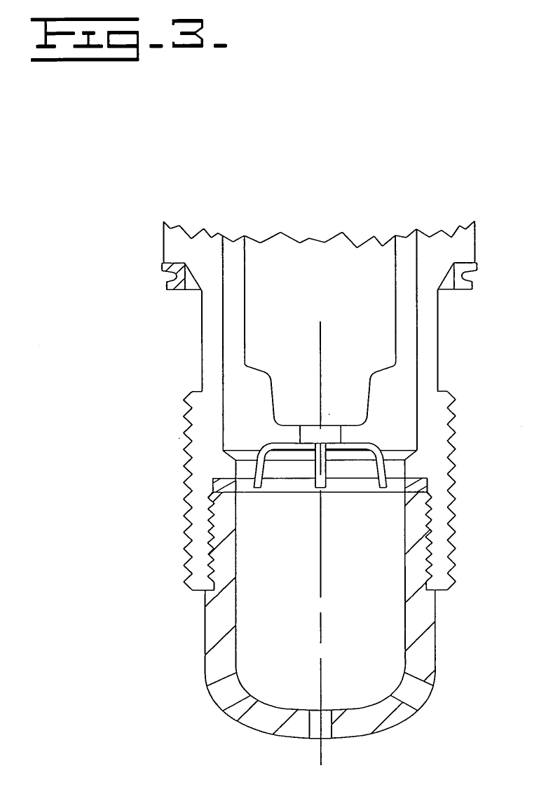

Referring now to FIG. 3, there is illustrated an enlarged sectional view of the lower portion 90 of the spark plug 50. In FIG. 3, the pre-combustion chamber 86 is shown as being defined substantially by the base portion 98 and the end cap 82. The wall 99 of the base portion 98 partially defines the pre-combustion chamber 86 and partially encloses an electrode carrier 94 and an electrode extension 96. The end cap 82 is configured to be assembled with the base portion 98 to substantially enclose the electrode carrier 94 and electrode extension 96. The pre-combustion chamber 86 is defined therein, as was described above. The end cap 82 has at least one central orifice 76 and a plurality of spaced orifices 78 formed therein, as was also described above. The end cap 82 further includes a top portion 110 and a flanged portion 112 extending away from the top 110. The flanged portion 112 is configured to cooperate with the wall 99 of the base portion 98 so that the flanged portion 112 securely connects the end cap 82 to the base portion 98. The attachment mechanism between the base portion 98 and the end cap 82 will be described in greater detail below.

As is also shown in FIG. 3, aligned with the axis 80 and extending from the insulator 56 is the electrode carrier 94. An ignition electrode extension 96 is mounted on the electrode carrier 94. The electrode extension 96 includes a plurality of arms 106. Each of the arms 106 cooperates with a mass electrode ring 102 to define a spark gap 104. It should be appreciated that the size of the gap 104 has been exaggerated in the Figures to show the space between the electrode extension 96 and the mass electrode ring 102. The mass electrode ring 102 serves as a ground electrode for the spark plug 50 and would be made of a material that is effective in the creation of a spark. The material could be a precious metal, such as platinum, nickel, tungsten, or iridium. It should be appreciated that other materials could also be used depending on the costs or desired performance. Alloys of these materials could also be used if so desired.

Each of the arms 106 includes a first portion 116 that extends from the electrode extension 96 substantially perpendicular to the axis 80 and towards the base wall 99. Each arm 106 also has a second portion 118 that extends from the end of each first portion 116. The second portions 118 are angled away from the first portions 116 and towards the pre-combustion chamber 86 such that the second portions 118 are substantially parallel to the wall 99 and the axis 80. Although the electrode extension 96 is illustrated as being generally cup shaped with a plurality of arms 106, it should be appreciated that the electrode extension 96 could be formed as a complete cup, or have any other suitable design. Additionally, the arms 106 could be made of platinum or any of the other materials listed above.

According to the illustrated embodiment, a shoulder 100 is formed on the base portion 98. The shoulder 100 is formed at a position that is substantially in the same plane as the second portions 118 of the arms 106 of the electrode extension 96. The shoulder 102 is sized and shaped so that the mass electrode ring 102 can be seated on the shoulder 100. This allows the ring 102 to be positioned near the second portions 118 of the electrode extension 96. Additionally, there is a space between the ring 102 and the second portion 118 of each arm 106 of the electrode extension 96. The space defines the spark gap 104. A spark that is generated within the spark gap 104 initiates the combustion process, as is generally known in the art. It should be appreciated that the mass electrode ring 102 could be secured within the pre-combustion chamber 86 adjacent the arms 106 of the electrode extension 96 in any suitable manner such as by welding, press fitting, or using any other suitable mechanism if it is so desired. Alternatively, the mass electrode ring 102 is secured in place as will be described below.

As was noted above, the end cap 82 is configured to cooperate with the base portion 98 so that the end cap 82 will be securely connected to the base portion 98, and therefore, to the spark plug 50. To facilitate such a connection, the flanged portion 112 has a length L that is sized to allow the flanged portion 112 to fit within the base portion 98. In addition, the length L of the flanged portion 112 is such that an end 114 of the flanged portion 112 captures the mass electrode ring 102 between the flanged portion 112 of the end cap 82 and the shoulder 100 formed on the base portion 98. The use of compression to secure the ring mass electrode 102 in place helps to maintain the location and spacing of the spark gap 104 within the pre-combustion chamber 86. As shown, the length L of the flanged portion can be slightly longer than the length l of the wall 99. The purpose of such a design would be to ensure to an assembler or maintenance worker that the ring 102 is captured between the end 114 of the flanged portion 112 and the shoulder 100 of the base portion 99. Additionally, the difference between the lengths L and I could define a small space in which the spot weld 108 could be located.

In addition to the structure described above, the end cap 82 is configured to releasably connect to the base portion 98 to define the pre-combustion chamber 86. In order to maintain structural integrity in a high temperature and high-pressure environment, the end cap 82 must be securely connected to the base portion 98. Therefore, according to the embodiment shown in FIG. 3, a portion of an outer surface 120 of the flanged portion 112 of the end cap 82 is threaded. The threaded portion of the outer surface 120 of the flanged portion 112 is configured to cooperate with a threaded portion 115 of the wall 99 of the base portion 98.

As can be seen in FIG. 3, an upper portion 124 of the wall 99 of the base portion 98 is configured to align with a shoulder 126 formed on a lower surface 128 of the end cap 82. Thus, when the end cap 82 and the base portion 98 are assembled, the shoulder 126 of the end cap 82 is nearly seated (or can be seated) against the upper portion 124 of the wall 99 of the base portion 98. In a manner that is similar to that described above with respect to the length L of the flange portion 112 of the end cap 82, the length l of a portion of the wall 99 of the base portion 98 is such that when the end cap 82 and base portion 98 are assembled, the components are joined together to define a substantially enclosed (but for the orifices 76 and 78) pre-combustion chamber 86.

Other configurations of the above spark plug 50 could be used without changing the invention. However, in this application the configurations as defined are intended to enhance the manufacturing process, provide serviceability, increase the longevity of the spark plug 50, and reduce emissions emitted from the engine 10.

### INDUSTRIAL APPLICABILITY

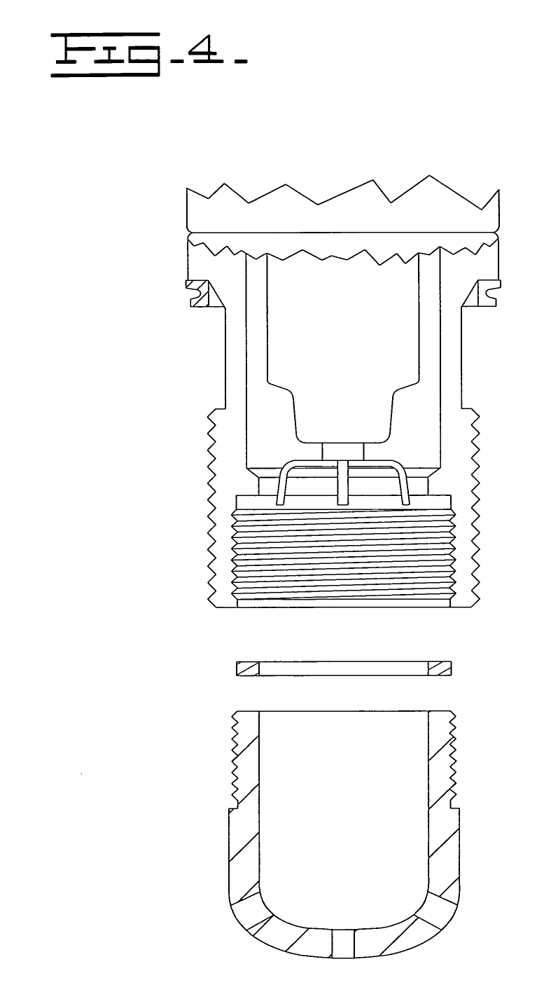

To highlight some of the novel features of the spark plug 50 according to the described embodiments, FIG. 4 depicts an exploded cross-sectional view of a portion of the spark plug 50. In particular, the base portion 98, the end cap 82, and the mass electrode ring 102 are shown. As would be evident to one skilled in the art, the flanged portion 112 is configured to be received against the wall 99 of the base portion 98. Additionally, the threaded outer surface 120 of the flanged portion 112 is designed to cooperate with the threaded portion 115 of the wall 99 of the base portion 98. In the assembled position, the mass electrode ring 102 fits around the electrode carrier 94 and the electrode extension 96 and seats on the shoulder 100 of the base. The end cap 82 is then threadably engaged with the base portion 98. In the illustrated embodiments, the end cap 82 is threaded into the base portion 98 until the mass electrode ring 102 is securely held between the shoulder 100 and the end cap 82. It should be appreciated that an additional small spot weld, indicated schematically at 108, could be used to hold the end cap 82 in place relative to the base portion 98 if it is so desired.

It should be appreciated that in lieu of the mass electrode ring 102, the entire end cap 82 can be manufactured of the same material, as the ring 102. The material would be a precious metal, such as platinum, nickel, tungsten, or iridium. However, to reduce the cost of the components, only the smaller ring 102 can be made of the precious metal material. Additionally, the use of the mass electrode ring 102 allows the end cap 82 to be made of a material, such as carbon steel, that can be more easily secured to the base portion 98. For example, if the end cap 82 were to be welded to the base portion 98, a steel-to-steel weld would be stronger than a precious metal to steel weld.

The benefits of threading the end cap 82 onto the base portion 98 will be described next. Using a threaded, or other releasable connection, between the end cap 82 and the base portion 98 allows the interior of the spark plug 50 to be accessible. Such access can be useful for several reasons. During use or operation of the spark plug 50, the size of the spark gap 104 can change due to erosion of the mass electrode ring 102 caused by repeated spark events within the spark plug 50. Therefore, accessibility allows the spark gap 104 to be inspected and adjusted as needed without having to replace the entire spark plug 50. Additionally, the mass electrode ring 102 can be radially repositioned to provide a “clean” surface upon which the spark event can occur thereby increasing the service life of the ring 102, and therefore of the spark plug 50. Alternatively, the mass electrode ring 102 could be replaced entirely if the erosion reaches a critical point where adjustments to the spark gap 104 would no longer be effective. In experimental use, access to the interior of the spark plug 50 could be useful if it is desired to try mass electrode rings that are made of different materials, or to vary the spark gap 104 spacing, to determine different operational characteristics. Although a spot weld 108 was described above as being an option to additionally hold the end cap 82 to the base portion 98, it should be appreciated that access to the interior of the spark plug 50 would not be hindered since the spot weld 108 could be easily cut open (and wherein a conventional full weld would be more difficult to open).

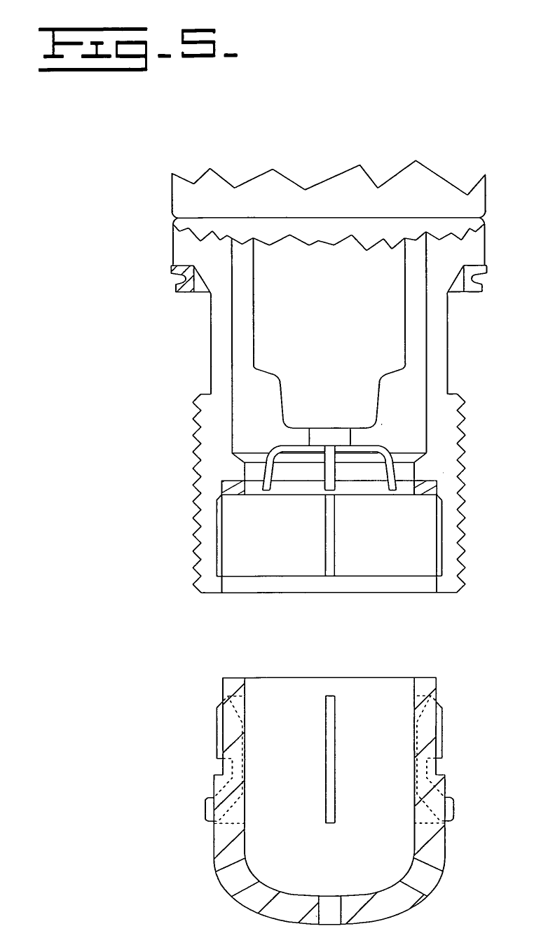

It should be appreciated that other connecting mechanisms can also be used to releasably connect an end cap to a base portion. In particular, in the embodiment shown in FIG. 5, a first connecting mechanism formed on the wall 99′ of a base portion 98′ is configured to cooperate with a second connecting mechanism formed on a flanged portion 112′ of an end cap 82′ to releasably connect the two components together. For example, and as shown in FIG. 5, the connecting mechanism could include retractable prongs 122 formed on the end cap 82′ and corresponding slots 130 formed on the base portion 98′. The prongs 122 are configured to be received in slots 130 formed in the wall 99′ of the base portion 98′. To release the prongs 122 from the slots 130, a button 132 located on the end cap 82′ would be depressed to retract the prongs 122 them to disengage the slots 130 of the base portion 98′. Once the prongs 122 are disengaged from the slots 130, the end cap 82′ could be removed from the base portion 98′. The prongs 122 are connected to the buttons 132 by a connecting arm, or other suitable mechanism, shown schematically at 134 in FIG. 5. Alternatively, a similar configuration could be designed using tabs or other similar features such that the depression of a button or lock disengages the tabs from openings formed in the base portion 98′. It should be appreciated that the prongs 122 or tabs designed could be reversed so that the slots 130 are formed on the end cap 82′ and the prongs 122 or tabs are formed on the base portion 98′ (not shown). It is anticipated that any of the designs described in this section would be configured so that the attachment mechanisms can withstand the temperature and pressures that result during operation of the pre-combustion spark plug 50′

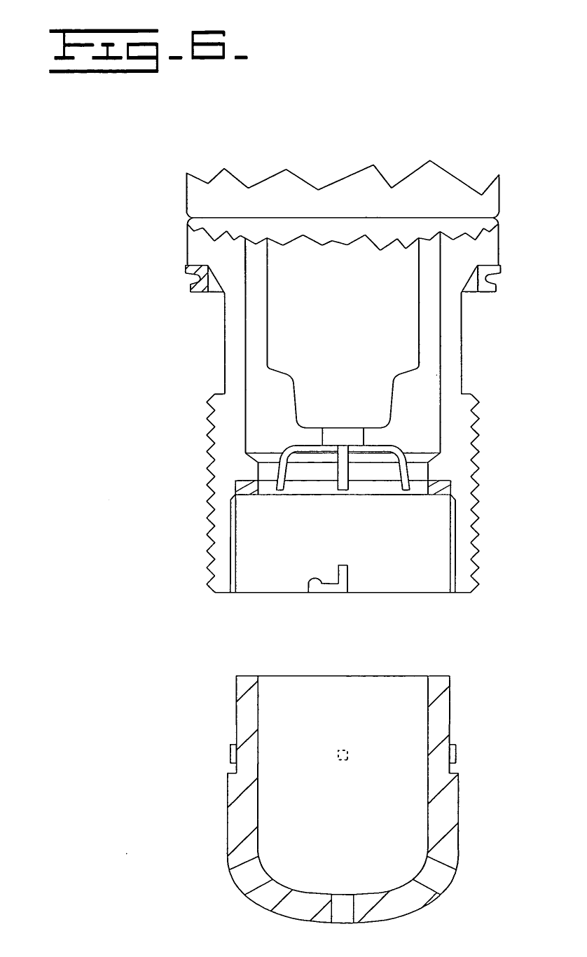

In an alternate embodiment of the invention, as shown in FIG. 6, the end cap 82″ could be releasably connected to the base portion 98″ by a bayonet coupling 136. The bayonet coupling 136 is similar to that used on prescription containers wherein a tab 138 on the end cap 82″ would be pushed against a bayonet 148 on the base portion 98″ and rotated to release the end cap 82″ from the base portion 98″. To secure the end cap 82″ to the base portion 98″, the end cap 82″ would also be pressed against the base portion 98″ and rotated in the opposite direction. The tab 138 would thereby engage the bayonet 148 formed on the base portion 98″ and be retained therewith. It is anticipated that any of the designs described in this section would be configured so that the attachment mechanisms can withstand the temperature, pressures, and other conditions that result during operation of the pre-combustion spark plug 50″. It can be appreciated that other alternate mechanisms that are not shown could also be used to connect an end cap to a base portion. Examples of these alternate mechanisms include crimping an end cap to a base, press fitting an end cap to a base, either of press fitting and crimping plus welding, welding alone, pinning, using a retaining ring, or using an interlocking thread, or by any other means for releasably connecting two components.

In an alternate embodiment of a spark plug 140 shown in FIG. 7, the end cap 142 is formed having a parabolic shape. In addition, the electrode mechanism 144 shown in this embodiment is slightly different than that described above. However, the operation of the electrode mechanism 144 shown in FIG. 7 is generally known in the art and will not be described in detail. The end cap 142 according to this embodiment can be connected to the base portion 146 by any of the connecting mechanisms described above (threads, retractable prongs, bayonet coupling, etc.) so that the end cap 142 is releasably connected to the base portion 146. In the illustrated embodiment, threads 148 on the end cap 142 cooperate with threads 150 on the base portion 146 threadably engage each other to form the releasable connection between the end cap 142 and the base portion 146 in a manner that is substantially similar to that which was described above.

The construction of the spark plugs shown in any of the above-described embodiments provides for easy manufacturing, maintenance, reduced costs, and enhanced combustion processes, thereby reducing emissions. For example, with the end cap 82 and the base portion 98 being separate components releasably held together, the manufacturing process and maintenance is enhanced because the interior of the plug can be accessed. The use of such a configuration could reduce or eliminate pre-ignition and other detonation problems enabling the timing to be advanced, thereby further optimizing engine performance. In addition, the accessibility of the pre-combustion chamber 86 allows for increases serviceability and reduces replacement and repair costs.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

### LIST OF ELEMENTS

TITLE: Pre-Chambered Type Spark Plug

FILE: 05-849

10 Spark Ignition Engine

12 Block

14 Cylinder Bore

16 Piston

18 Cylinder Block Top Surface

22 Cylinder Head

24 Cylinder Head Top Surface

26 Cylinder Head Bottom Surface

28 Gasket

30 Combustion Chamber

34 Intake Valve Mechanism

36 Exhaust Valve Mechanism

42 Stepped Through Bore

44 Fastening Mechanism

50 Spark Plug

52 Connecting Portion

54 Insulator Retention Region

56 Insulator

60 Terminal

70 Plug Shell

72 Connecting Region

74 Tip & Orifice Portion

76 Central Orifice

78 Spaced Orifices

80 Axis

82 End Cap

86 Pre-combustion Chamber

90 Lower Portion

94 Electrode Carrier

96 Ignition Electrode Extension

98 Base Portion

99 Wall

100 Shoulder

102 Mass Electrode Ring

104 Spark Gap

106 Arms

108 Spot Weld

110 End Cap Top Portion

112 Flanged Portion

114 End Portion of the Flanged Portion

115 Threaded Portion of Wall

116 Arm First Portion

118 Arm Second Portion

120 Outer Surface of Flanged Portion

122 Retractable Plugs

124 Upper Portion of Wall

126 End Cap Shoulder

128 Lower Surface of End Cap

130 Slots

132 Button

134 Connecting Arm

136 Bayonet Coupling

138 Tab

140 Spark Plug

142 End Cap

144 Electrode Mechanism

146 Base Portion

148 Threads on the End Cap

150 Threads on the Base Portion

What is claimed is:

1. A pre-chamber spark plug comprising:
a base portion;
an electrode positioned within the base portion; and
an end cap, wherein the end cap is releasably connected to the base portion of the spark plug.

2. The spark plug defined in claim 1 wherein the end cap is releasably connected to the base portion by threads.

3. The spark plug defined in claim 1 wherein the end cap is releasably connected to the base portion by at least one retractable prong.

4. The spark plug defined in claim 3 includes a button formed on the end cap wherein the button is connected to the retractable prong to cause a retraction of the prong when the button is depressed.

5. The spark plug defined in claim 1 wherein the end cap is releasably connected to the base portion using a bayonet coupling.

6. The spark plug defined in claim 1 including a mass electrode ring positioned adjacent the electrode wherein a space between the ring and the electrode defines a spark gap.

7. The spark plug defined in claim 6 wherein the mass electrode ring is held in place between the end cap and the base portion.

8. The spark plug defined in claim 1 further comprising a spot weld for securing the end cap to the base portion.

9. A method of making a pre-chamber spark plug comprising:
providing a base portion having a wall with a first connecting mechanism formed thereon;
providing an electrode positioned within and supported by the base portion;
providing an end cap having a top portion and a flanged portion, the flanged portion having a second connecting mechanism formed thereon; and
connecting the end cap to the base portion wherein the first connecting mechanism is configured to cooperate with the second connecting mechanism to releasably connect the end cap and the base portion together.

10. The method defined in claim 9 wherein the first connecting mechanism and second connecting mechanism are cooperating threads.

11. The method defined in claim 9 wherein the first connecting mechanism is a slot, the second connecting mechanism is a retractable prong, wherein the slot is sized and shaped to accommodate the retractable prong.

12. The method defined in claim 9 wherein the first connecting mechanism is a bayonet, the second connecting mechanism is a tab, wherein the bayonet and tab are cooperating portions of a bayonet coupling mechanism.

13. The method defined in claim 9 further including the steps of:
providing a shoulder on the wall of the base portion;
seating a mass electrode ring on the shoulder of the base portion; and
securing the mass electrode ring in place between the flanged portion of the end cap and the shoulder of the base portion.
